(19) United States
(12) Patent Application Publication
(10) Pub. No.: US 2018/0287475 A1
(43) Pub. Date: Oct. 4, 2018

(54) VIBRATING MOTOR

(71) Applicant: Nidec Seimitsu Corporation, Ueda-shi (JP)

(72) Inventors: Zendi MORI, Ueda-shi (JP); Mitsuru MURATA, Ueda-shi (JP)

(21) Appl. No.: 15/921,707

(22) Filed: Mar. 15, 2018

(30) Foreign Application Priority Data
Mar. 30, 2017 (JP) 2017-068786

(51) Int. Cl. H02K 33/02

(52) U.S. Cl. CPC H02K 33/02

(57) ABSTRACT

A vibrating motor includes a stationary portion, a vibrating body, and an elastic member. The stationary portion includes a casing, a coil, a first yoke, and a second yoke. The vibrating body includes a magnet on a radially outer side of the second yoke. The vibrating body is supported so as to be able to vibrate vertically with respect to the stationary portion. The elastic member is disposed between the casing and the vibrating body. The first yoke has a vertically extending columnar shape. The first yoke is fixed to the casing and disposed on a radially inner side of the coil. The second yoke includes a bottom and a wall. The bottom has a thickness in the vertical direction and is disposed on the coil. The wall extends downward from an outer rim of the bottom and faces an outer circumferential surface of the coil in the radial direction.

### CROSS REFERENCE TO RELATED APPLICATIONS

This application claims the benefit of priority to Japanese Patent Application No. 2017-068786 filed on Mar. 30, 2017. The entire contents of this application are hereby incorporated herein by reference.

### BACKGROUND OF THE INVENTION

### 1. Field of the Invention

The present disclosure relates to vibrating motors.

### 2. Description of the Related Art

Various devices, such as smartphones, in the related art include a vibrating motor. There are two types of vibrating motors: a type that performs linear vibration in the lateral direction and a type that performs linear vibration in the vertical direction. Human beings who are users tend to feel vertical vibration rather than lateral vibration. An example of conventional vertical linear vibration motors is disclosed in U. S. Patent Application, Publication No. 2016/0172950.

The vibrating motor disclosed in U. S. Patent Application, Publication No. 2016/0172950 includes a bracket, a case, a coil, a yoke, a vibrating body, and an elastic member. The vibrating body includes a magnet and a weight.

Both of the magnet and the weight have a ring shape. The magnet is fixed to the radially inner side of the weight. The vibrating body is disposed above the bracket. The elastic member is disposed between the bracket and the vibrating body and supports the vibrating body so that the vibrating body can vibrate in the vertical direction.

The coil disposed on the radially inner side of the weight is fixed at the lower part to the bracket. The yoke includes a columnar base, a projecting portion projecting downward from the base, and a circular plate located above the base. The projecting portion is fitted in the hole of the bracket located on the radially inner side of the coil, so that the yoke is fixed to the bracket. The base is disposed on the radially inner side of the coil. The circular plate is located above the coil. The circular plate has a shape expanding radially outward from the base.

Therefore, the distance between the outer rim of the yoke and the magnet is short at the circular plate. This increases the efficiency of the magnetic flux, enhancing the power of the vibrating motor.

However, in order to further enhance the power of the vibration motor disclosed in U. S. Patent Application, Publication No. 2016/0172950, the vertical thickness of the circular plate of the yoke has to be increased. This results in an increase in the vertical size of the vibrating motor.

To avoid increasing the vertical size, the thickness of the circular plate may be increased downward. However, this decreases the vertical height of the coil, resulting in a decrease in the number of turns of the coil. This causes a problem in that an attractive force (reactance torque) due to the coil decreases.

### SUMMARY OF THE INVENTION

In an embodiment of the present disclosure, a vibrating motor includes a stationary portion including a casing, a coil, a first yoke, and a second yoke; a vibrating body including a magnet, the vibrating body being supported so as to be able to vibrate in a vertical direction with respect to the stationary portion; and an elastic member disposed between the casing and the vibrating body. The first yoke has a columnar shape extending in the vertical direction, the first yoke being fixed to the casing, the first yoke being disposed on an inner side of the coil in a radial direction. The second yoke includes a bottom having a thickness in the vertical direction, the bottom being disposed on the coil; and a wall extending downward from an outer rim of the bottom, the wall facing an outer circumferential surface of the coil in the radial direction. The magnet is disposed on an outer side of the second yoke in the radial direction.

In an embodiment of the present application, a decrease in attractive force due to the coil can be reduced or eliminated without the need for increasing the vertical size of the vibrating motor in order to increase the power of the vibrating motor. Thus, a vertical linear vibration motor suitable for increasing the power can be provided.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a vibrating motor according to a first embodiment of the present disclosure, illustrating the appearance thereof.

FIG. 2 is a perspective cross-sectional view of the vibrating motor in FIG. 1 taken along line A-A.

FIG. 3 is a cross-sectional view of the vibrating motor in FIG. 1 taken along line A-A.

FIG. 4 is a partial sectional perspective view of the vibrating motor cut at a lower part.

FIG. 5 is a cross-sectional view of a yoke according to a modification.

FIG. 6 is a cross-sectional view of a vibrating motor according to a second embodiment of the present disclosure.

### DETAILED DESCRIPTION OF THE PREFERRED EMBODIMENTS

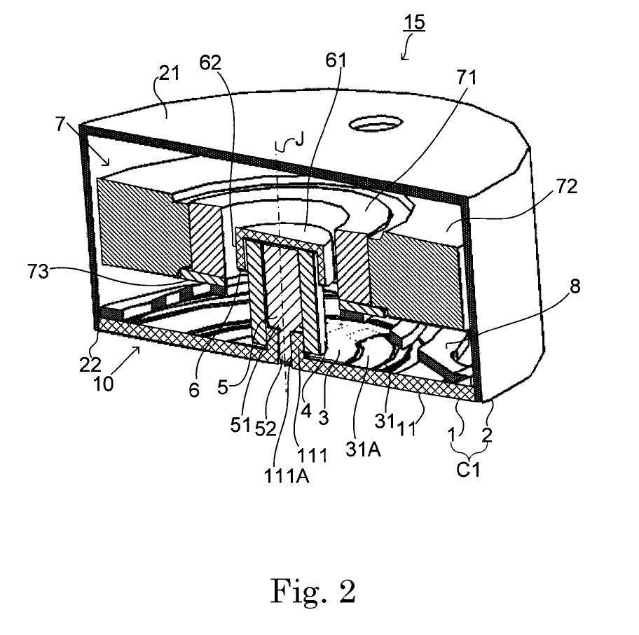

Embodiments of the present disclosure will be described hereinbelow with reference to the drawings. A direction in which the central axis J of the vibrating motor extends is referred to as “vertical direction”. For example, the upper side of the plane of FIG. 2 is the upper side in the vertical direction. A radial direction centered on the central axis J is simply referred to as “radial direction”, and a circumferential direction centered on the central axis J is simply referred to as “circumferential direction”. It is to be understood that “vertical direction” does not indicates the positional relationship and direction when the vibration motor is installed in an actual apparatus.

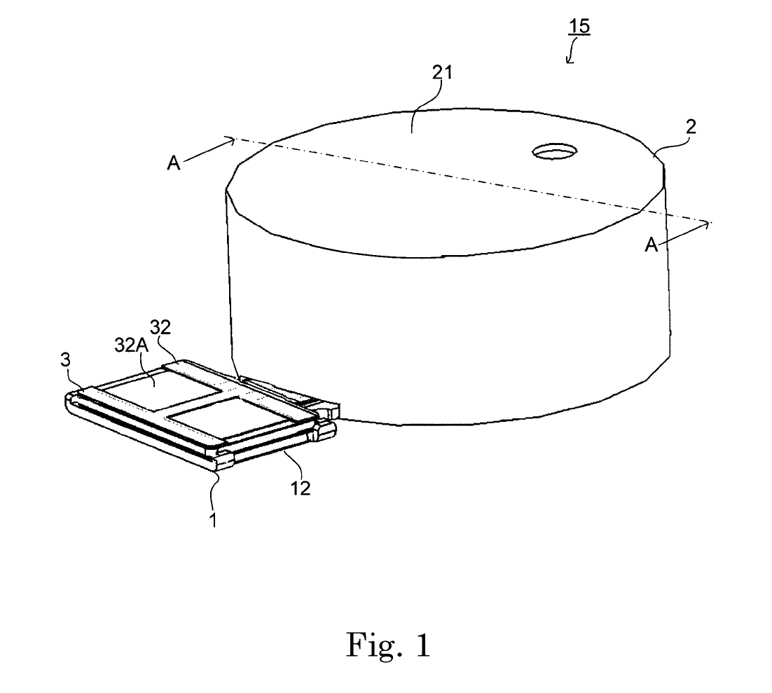

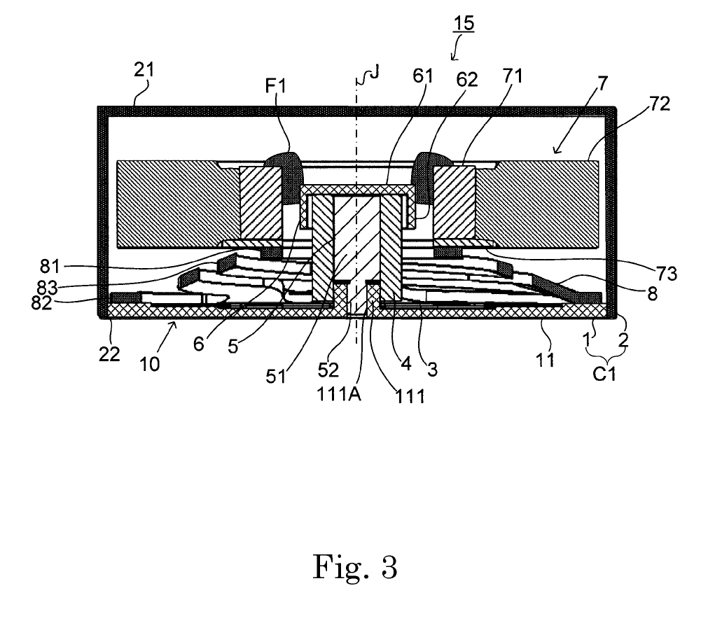

FIG. 1 is a perspective view of a vibrating motor 15 according to a first embodiment of the present disclosure, illustrating the appearance thereof. FIG. 2 is a perspective cross-sectional view of the vibrating motor in FIG. 1 taken along line A-A. FIG. 3 is a cross-sectional view of the vibrating motor in FIG. 1 taken along line A-A.

The vibrating motor 15 roughly includes a stationary portion 10, a vibrating body 7, and an elastic member 8. The stationary portion 10 includes a casing C1, a flexible printed circuit (FPC) board 3, a coil 4, a first yoke 5, and a second yoke 6.

The casing C1 includes a base plate 1 and a case 2. The base plate 1 is a plate-like member made of, for example, a cold-rolled steel sheet. The base plate 1 expands in the vertical direction from the central axis J.

The case 2 is a cylindrical cover member including a cover 21 at the top. That is, the case 2 includes an opening 22 at the lower end. The case 2 is made of, for example, stainless steel (SUS). The base plate 1 includes a substantially circular plate-like first base portion 11 and a substantially rectangular plate-like second base portion 12, and the first base portion 11 and the second base portion 12 are connected together. By fitting an opening 22 on the first base portion 11, the case 2 is mounted to the base plate 1 from above. The case 2 is fixed to the base plate 1 by welding or fusing. The second base portion 12 is disposed outside the case 2.

The FPC board 3 is a substrate including wire lines for supplying an electric current to the coil 4. The FPC board 3 is a multi-layer of a base film layer, a wiring layer, and a resist layer. The base film layer is made of, for example, polyimide, and has flexibility and insulating properties. The wiring layer is made of, for example, copper foil, and is disposed on the base film layer. The resist layer is made of, for example, polyimide, and has insulating properties. The resist layer is disposed on the wiring layer. The resist layer is not disposed at an externally conductive portion of the wiring layer. The portion is exposed upward. The FPC board 3 is fixed to the base plate 1 with an adhesive or an adhesive sheet.

The FPC board 3 includes a substantially circular plate-like first substrate portion 31 and a substantially rectangular plate-like second substrate portion 32. The first substrate portion 31 and the second substrate portion 32 are connected together. The first substrate portion 31 is disposed on the first base portion 11. The first substrate portion 31 includes two land portions 31A. The land portions 31A extend in an arc shape in the circumferential direction on the radially outer side of the coil 4 and are exposed upward. The land portions 31A are electrically connected to lead wires extracted from the coil 4. The second substrate portion 32 is disposed on the second base portion 12. The second substrate portion 32 includes two terminal portions 32 exposed upward. Each of the terminal portions 32A is connected to a corresponding one of the land portions 31A with the wiring layer. This allows the coil 4 to be supplied with an electric current by applying a voltage to the terminal portions 32A from the outside.

The first yoke (a central yoke) 5 has a generally columnar shape extending in the vertical direction and includes a base 51 and a projecting portion 52. The first yoke 5 is made of, for example, cut steel, and has magnetic properties. The base 51 has a columnar shape extending in the vertical direction. The projecting portion 52 has a columnar shape projecting downward from the base 51. The diameter of the projecting portion 52 is smaller than the diameter of the base 51.

The first base portion 11 includes a fixing portion 111 protruding upward and centered on the central axis J. The fixing portion 111 includes a through-hole 111A passing therethrough in the vertical direction. The first yoke 5 is fixed to the fixing portion 111 by fitting the projecting portion 52 in the through-hole 111A to place the base 51 on the fixing portion 111. The first yoke 5 is fixed by press-fitting or caulking at the position where the projecting portion 52 is fitted.

The coil 4 is formed by winding a coil wire, for example, a fused polyurethane copper wire, around the central axis J in the vertical direction. The lower part of the coil 4 is fitted on the radially outer side of the fixing portion 111. The lower end face of the coil 4 is fixed to the first substrate portion 31 with an adhesive or an adhesive sheet. The coil 4 is disposed on the radially outer side of the first yoke 5. The upper end face of the coil 4 is aligned with the upper end face of the base 51 in the vertical direction. That is, the upper end faces of the coil 4 and the base 51 are flush with each other.

The second yoke (a back yoke) 6 is made of, for example, a cold-rolled steel sheet and has magnetic properties. The second yoke 6 includes a bottom 61 and a wall 62. The bottom 61 is a substantially circular plate having a thickness in the vertical direction and is disposed on the same plane formed by the upper end faces of the coil 4 and the base 51. The diameter of the bottom 61 is larger than the outside diameter of the coil 4. That is, the bottom 61 expands radially outward from the coil 4, with the central axis J as the center.

The wall 62 has a cylindrical shape protruding downward from the outer rim of the bottom 61. That is, the inner circumferential surface of the wall 62 is located on the radially outer side of the outer circumferential surface of the coil 4 to face the outer circumferential surface in the radial direction. The second yoke 6 is fixed to the first yoke 5 by fixing the lower surface of the bottom 61 to the upper end face of the base 51 with an adhesive or an adhesive sheet. The center of a magnet 71 is aligned with the wall 62 in the vertical direction, with no current flowing through the coil 4. This allows the amount of vibration of the vibrating body 7 to rise quickly from zero to peak at the start of current supply to the coil 4, as compared with a configuration in which the center of the magnet 71 is not aligned with the wall 62 in the vertical direction. In other words, responsibility at the start of the operation of the vibrating motor 15 can be improved. In one example, the center of the wall 62 is substantially aligned with the center of the magnet 71 in the vertical direction, with no current supplied to the coil 4.

The vibrating body 7 includes the magnet 71, a weight 72, and a pole piece 73. The magnet 71 is made of, for example, a sintered neodymium magnet, and has a cylindrical shape having a ring shape in top view. The weight 72 is made of, for example, a tungsten alloy, and has a substantially cylindrical shape having a ring shape in top view. The magnet 71 is disposed on the radially inner side of the weight 72. The outer circumferential surface of the magnet 71 and the inner circumferential surface of the weight 72 are fixed together with an adhesive or an adhesive sheet. The pole piece 73 is a ring-shaped plate-like member made of, for example, a SUS material, and having magnetic properties. The pole piece 73 is disposed under the magnet 71 and is fixed to the lower surface of the magnet 71 with an adhesive or an adhesive sheet.

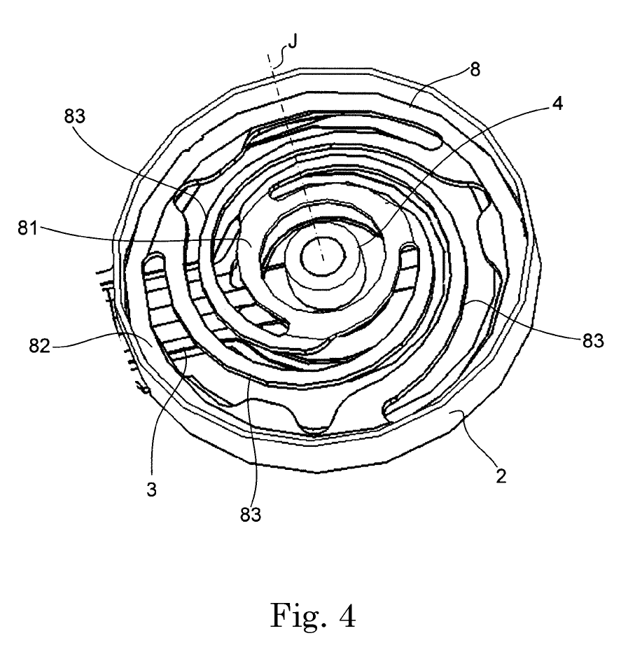

The elastic member 8 is a leaf spring member made of, for example, a SUS material. To illustrate the configuration of the elastic member 8, a partial sectional perspective view of the vibrating motor 15 cut at a lower part is shown in FIG. 4. The elastic member 8 includes a first ring portion 81, a second ring portion 82 located below the first ring portion 81, and three connecting portions 83 connecting the first ring portion 81 and the second ring portion 82 together. Three portions of the outer rim of the ring-shaped first ring portion 81 disposed at regular intervals in the circumferential direction are connected to the inner rim of the second ring portion 82 with the connecting portions 83 extending in the circumferential direction while extending radially outward. This configuration allows the elastic member 8 to expand and contract in the vertical direction.

The elastic member 8 is disposed between the vibrating body 7 and the first base portion 11. The coil 4 is disposed on the radially inner side of the first ring portion 81. The elastic member 8 is fixed to the base plate 1 by fixing the lower surface of the second ring portion 82 to the upper surface of the first base portion 11 by welding or fusing. The elastic member 8 is fixed to the vibrating body 7 by fixing the upper surface of the first ring portion 81 to the lower surface of the pole piece 73 by welding or fusing.

Thus, the vibrating body 7 is supported by the elastic member 8 so as to vibrate in the vertical direction. The inner circumferential surface of the magnet 71 is located on the radially outer side of the outer circumferential surface of the second yoke in the radial direction and faces the outer circumferential surface in the radial direction.

By supplying a current to the coil 4, a magnetic flux passing through a magnetic path formed by the coil 4, the first yoke 5, and the second yoke 6 is generated. The mutual action of the generated magnetic flux and a magnetic flux passing through a magnetic path formed by the magnet 71 and the pole piece 73 causes the vibrating body 7 to vibrate in the vertical direction. Thus, the vibrating motor 15 is a vertical linear vibration motor.

In particular, since the second yoke 6 is constituted by the bottom 61 and the wall 62, the radial distance between the second yoke 6 and the magnet 71 can be short, and the short portion can be long in the vertical direction, thereby increasing the power of the vibrating motor 15. In this case, there is no need to increase the thickness of the bottom 61, thus preventing the vertical size of the vibrating motor 15 from increasing. Furthermore, there is no need to decrease the vertical length of the coil 4, thereby preventing the number of turns from decreasing to reduce the attractive force (reactance torque).

In the case of a thick yoke, the yoke cannot be manufactured by low-cost press working but may be manufactured using a cutting tool, leading to high cost. In contrast, the second yoke 6 of the present embodiment does not need large thickness, so that it can be manufactured by low-cost press working.

Thus, the vibrating motor 15 according to the present embodiment includes the stationary portion 10 including the casing C1, the coil 4, the first yoke 5, and the second yoke 6, the vibrating body 7 including the magnet 71 and supported so as to vibrate in the vertical direction with respect to the stationary portion 10, and the elastic member 8 disposed between the casing C1 and the vibrating body 7. The first yoke 5 has a columnar shape extending in the vertical direction, is fixed to the casing C1, and is disposed on the radially inner side of the coil 4. The second yoke 6 includes the bottom 61 that is thick in the vertical direction and that is disposed on the coil 4 and the wall 62 extending downward from the other rim of the bottom 61 to face the outer circumferential surface of the coil 4 in the radial direction. The magnet 71 is disposed on the radially outer side of the second yoke 6.

With this configuration, there is no need to increase the vertical size of the vibrating motor in order to increase the power of the vibrating motor, and a decrease in the attractive force due to the coil can be prevented. Thus, the vibrating motor 15 is a vertical linear vibration motor suitable for increasing the power.

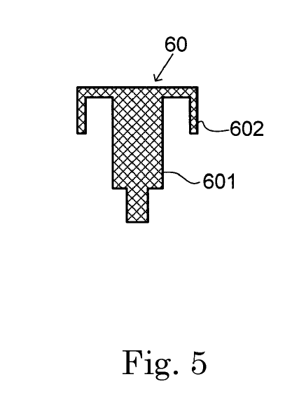

For the yoke, a yoke 60 including a first yoke 601 and a second yoke 602, which are made of the same member, may be used as illustrated in the cross-sectional view of FIG. 5. In this case, the first yoke 601 is fixed to the fixing portion 111. This eliminates the need for fixing the second yoke 602 to the first yoke 601, leading to reduction in the number of processes. However, as described above, forming the first yoke 5 and the second yoke as separate members makes each yoke have a simple shape, facilitating manufacture.

The vibrating motor 15 further includes a magnetic fluid F1 between the magnet 71 and the second yoke 6. The damper effect of the magnetic fluid F1 prevents the vibrating body 7 from excessively moving when the vibrating motor 15 is dropped, reducing or eliminating damage to the elastic member 8.

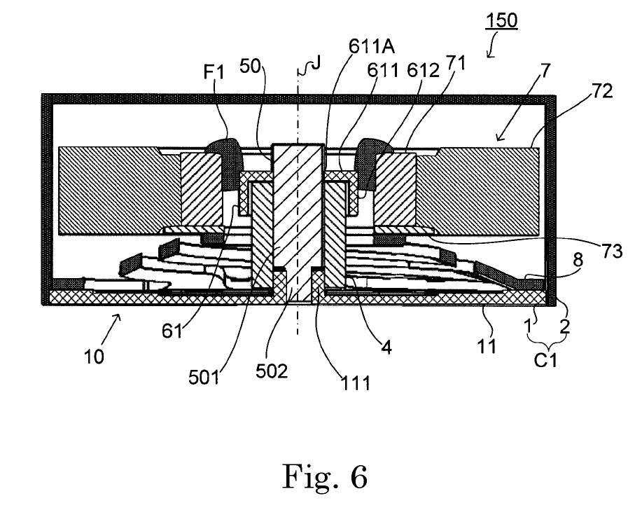

Next, a second embodiment, which is a modification of the first embodiment described above, will be described. FIG. 6 is a cross-sectional view of a vibrating motor 150 according to a second embodiment of the present disclosure, corresponding to FIG. 3. A first yoke 50 and a second yoke 70 of the vibrating motor 150 will be described as a difference from the configuration of the vibrating motor 15 according to the first embodiment.

The first yoke 50 includes a base 501 and a projecting portion 502. Although the configuration of the first yoke 50 is basically similar to the first yoke 5 according to the first embodiment, the vertical length of the base 501 is larger than the vertical length of the base 51. The projecting portion 502 is fixed to the fixing portion 111.

The second yoke 70 includes a bottom 611 and a wall 612. Although the configuration of the second yoke 70 is basically similar to the configuration of the second yoke 6 according to the first embodiment, the bottom 611 includes a through-hole 611A passing therethrough in the vertical direction. The base 501 is passed through the through-hole 611A. Therefore, the upper part of the base 501 protrudes upward from the bottom 611.

Also for the vibrating motor 150 according to the second embodiment, there is no need to increase the thickness of the bottom 611 in order to increase the power, and there is no need to decrease the vertical length of the coil 4, providing a configuration suitable for increasing the power.

In the present embodiment, the bottom 611 includes the through-hole 611A through which the first yoke 50 passes. Thus, at the manufacture of the vibrating motor 150, the second yoke 70 is fitted on the first yoke 50 from above so that the first yoke 50 passes through the through-hole 611A, with the coil 4 and the first yoke 50 assembled, and the second yoke 50 is moved downward, so that the second yoke 50 is placed on the coil 4. Accordingly, by moving the second yoke 70 downward in its positioned state, the second yoke 70 can be mounted without the distal end of the wall 612 coming into contact with the upper outer rim of the coil 4. That is, the ease-of-assembly of the second yoke 70 can be increased.

In the case of the present embodiment, the second yoke 70 is fixed to the coil 4 by fixing the lower surface of the bottom 611 to the upper end face of the coil 4 with an adhesive or an adhesive sheet.

Having described embodiments of the present disclosure, various modifications of the embodiments can be made within the scope of the spirit of the present disclosure.

The present disclosure can be used in vibrating motors provided in, for example, smartphones or wearable devices.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibrating motor comprising:
a stationary portion comprising a casing, a coil, a first yoke, and a second yoke;
a vibrating body comprising a magnet, the vibrating body being supported so as to be able to vibrate in a vertical direction with respect to the stationary portion; and
an elastic member disposed between the casing and the vibrating body,
wherein the first yoke has a columnar shape extending in the vertical direction, the first yoke being fixed to the casing, the first yoke being disposed on an inner side of the coil in a radial direction,
wherein the second yoke comprises:
a bottom having a thickness in the vertical direction, the bottom being disposed on the coil; and
a wall extending downward from an outer rim of the bottom, the wall facing an outer circumferential surface of the coilin the radial direction, and
wherein the magnet is disposed on an outer side of the second yoke in the radial direction.

2. The vibrating motor according to claim 1, wherein the first yoke and the second yoke are separate members.

3. The vibrating motor according to claim 2, wherein the bottom comprises a through-hole through which the first yoke passes.

4. The vibrating motor according to claim 1, wherein the first yoke and the second yoke are same members.

5. The vibrating motor according to claim 1, further comprising a magnetic fluid between the magnet and the second yoke.

6. The vibrating motor according to claim 2, further comprising a magnetic fluid between the magnet and the second yoke.

7. The vibrating motor according to claim 3, further comprising a magnetic fluid between the magnet and the second yoke.

8. The vibrating motor according to claim 4, further comprising a magnetic fluid between the magnet and the second yoke.

9. The vibrating motor according to claim 1, wherein a center of the magnet is aligned with the wall in the vertical direction, with no current flowing through the coil.

10. The vibrating motor according to claim 2, wherein a center of the magnet is aligned with the wall in the vertical direction, with no current flowing through the coil.

11. The vibrating motor according to claim 3, wherein a center of the magnet is aligned with the wall in the vertical direction, with no current flowing through the coil.

12. The vibrating motor according to claim 4, wherein a center of the magnet is aligned with the wall in the vertical direction, with no current flowing through the coil.

13. The vibrating motor according to claim 5, wherein a center of the magnet is aligned with the wall in the vertical direction, with no current flowing through the coil.

14. The vibrating motor according to claim 6, wherein a center of the magnet is aligned with the wall in the vertical direction, with no current flowing through the coil.

15. The vibrating motor according to claim 7, wherein a center of the magnet is aligned with the wall in the vertical direction, with no current flowing through the coil.

16. The vibrating motor according to claim 8, wherein a center of the magnet is aligned with the wall in the vertical direction, with no current flowing through the coil.
